(19) United States
(12) Patent Application Publication
(10) Pub. No.: US 2011/0302935 A1
(43) Pub. Date: Dec. 15, 2011

(54) LIQUID DISPENSING AND AUTOMATIC ICEMAKING ON NON-PLUMBED REFRIGERATOR

(75) Inventors: NIHAT CUR, SAINT JOSEPH, MI (US); GREGORY G. HORTIN, HENDERSON, KY (US); DEBRA E. STEEL, SAINT JOSEPH, MI (US)

(73) Assignee: WHIRLPOOL CORPORATION, BENTON HARBOR, MI (US)

(21) Appl. No.: 12/813,596

(22) Filed: Jun. 11, 2010

(51) Int. Cl. F25D 23/00; B67D 7/80; F25C 1/24

(52) U.S. Cl. 62/66; 62/390; 62/340; 222/1; 222/135; 222/146.6

(57) ABSTRACT

The present invention is directed towards a refrigerator including a door, a liquid reservoir, a dispenser mounted at the door for dispensing liquid, the dispenser having an outlet located above the liquid reservoir, and a pump in communication with the dispenser. Further provided is a method of operating a refrigerator including the steps of providing a refrigerator comprising a refrigerator cabinet, a door attached to the refrigerator cabinet, a liquid reservoir, and a dispenser mounted at the door for dispensing liquid through the door, the dispenser having an outlet located above the liquid reservoir, providing a pump having an inlet in communication with the liquid in the liquid reservoir and an outlet in communication with the dispenser, and providing a user interface in communication with the pump, whereby selectively entering a dispensing function input into the interface actuates the pump.

### FIELD OF THE INVENTION

The invention relates generally to the field of refrigerators. More specifically, but not exclusively, the present invention relates to a refrigerator that is not plumbed to an external water source.

### BACKGROUND OF THE INVENTION

The refrigerator is an appliance for the storage of food. The refrigerator generally has a refrigerator cabinet and a door attached to the cabinet. The cabinet generally defines a fresh food compartment that is kept at a low temperature by refrigeration means. The refrigerator door may have a through-the-door ice and water dispensing system to cut down on the opening and closing of the door. Often refrigerators are connected to an external source of water which is then routed to the dispensing system. Other refrigerators may be non-plumbed, i.e., not connected to an external source of water. Present non-plumbed refrigerators typically use a gravity based system to provide water to the dispenser and/or icemaker. Unfortunately, these types of systems lack the degree of control necessary for a multi-purpose refrigerator (icemaking, liquid dispensing, flavor dispensing and refillable bottle dispensing). What is needed is a refrigerator and method of operating a non-plumbed refrigerator which does not rely on gravity to move water throughout the refrigerator.

### SUMMARY OF THE INVENTION

In one aspect, the present invention is directed towards a refrigerator including a refrigerator cabinet, a door attached to the refrigerator cabinet, a liquid reservoir, a dispenser mounted at the refrigerator door for dispensing liquid through the door, the dispenser having an outlet located above the liquid reservoir and a pump having an inlet in communication with the liquid in the reservoir and an outlet in communication with the dispenser.

In another aspect of the invention, an icemaker pump may be provided having an inlet in communication with the liquid reservoir and an outlet in communication with an icemaker. A flavorant pump may also be provided having an inlet in communication with a flavor reservoir and an outlet in communication with the dispenser. Still further, a refillable bottle pump may be provided having an inlet in communication with a refillable bottle disposed within a bin and an outlet in communication with the dispenser.

In yet another aspect, a user interface may be provided at the door and is configured to be in communication with a pump. A dispensing function input is entered into a user interface that causes the pump to be actuated. The dispensing function may be selected from a set consisting of dispensing a liquid, dispensing ice, dispensing a flavored beverage, and dispensing from a refillable bottle.

In another aspect of the invention, a method is provided for operating a refrigerator comprising: providing a refrigerator comprising a refrigerator cabinet, a door attached to the refrigerator cabinet, a liquid reservoir, and a dispenser mounted at the door for dispensing liquid through the door, the dispenser having an outlet located above the liquid reservoir, providing a pump having an inlet in communication with the liquid in the liquid reservoir and an outlet in communication with the dispenser, and providing a user interface in communication with the pump, whereby selectively entering a dispensing function input into the interface actuates the pump.

Therefore it is a primary object, feature, or advantage of the present invention to improve upon the state of the art.

It is a further object, feature, or advantage of the present invention to provide a refrigerator which does not rely on gravity to move water from a holding reservoir to the dispenser, icemaker and the like.

Another object, feature, or advantage of the present invention is to provide a refrigerator, the operation of which can be selectively configured by a user via a user interface.

Yet another object, feature, or advantage of the present invention is to provide a method for operating a refrigerator.

One or more of these and/or other objects, features, and advantages of the present invention will become apparent from the specification and claims that follow. No single embodiment of the present invention need exhibit all of these objects, features, or advantages.

### BRIEF DESCRIPTION OF THE DRAWINGS

FIG. 1 is a perspective view of a refrigerator incorporating a multifunction user interface.

FIG. 2 is a section view from line 2-2 of FIG. 1 of the non-plumbed refrigerator and more specifically the liquid reservoir, icemaker, flavor reservoir, dispenser, and pumps.

FIG. 3 is a section view of a refrigerator showing a pump with an inlet in communication with a refillable bottle disposed within the door bin and an outlet in communication with the dispenser.

FIG. 4 is a block diagram in accordance with the present non-plumbed refrigerator.

FIG. 5 is a graphical representation of the user interface of the present non-plumbed refrigerator.

### DETAILED DESCRIPTION OF THE PREFERRED EMBODIMENT

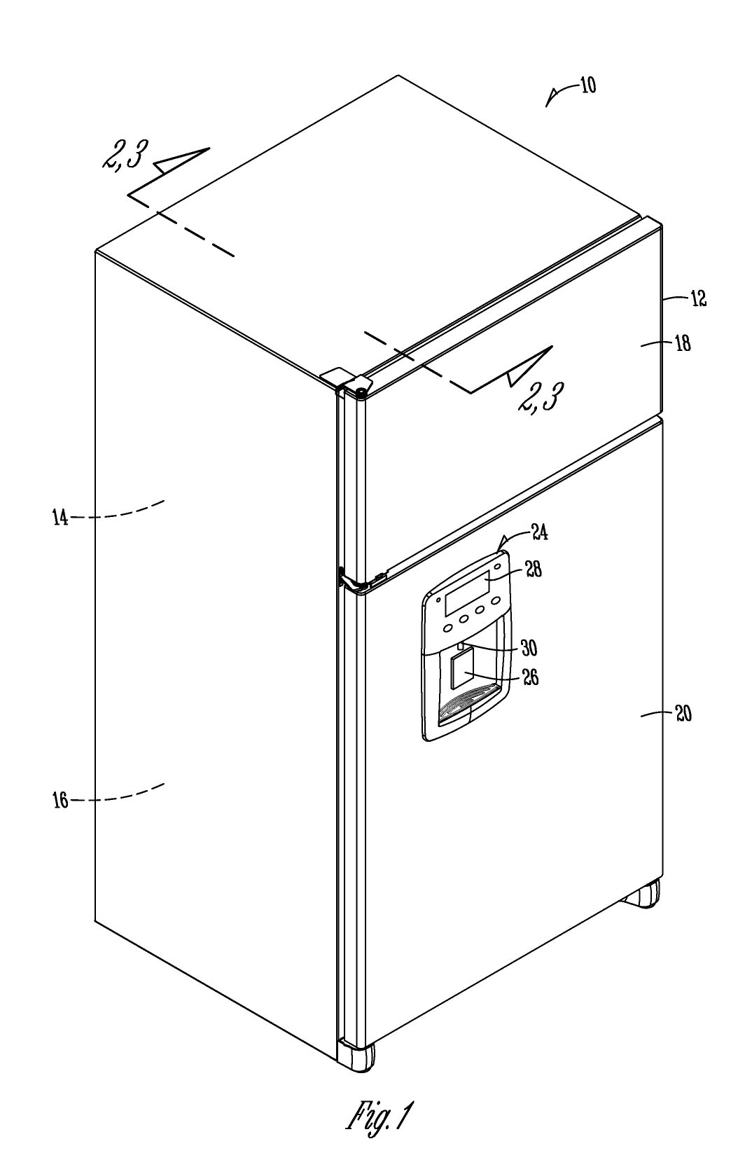

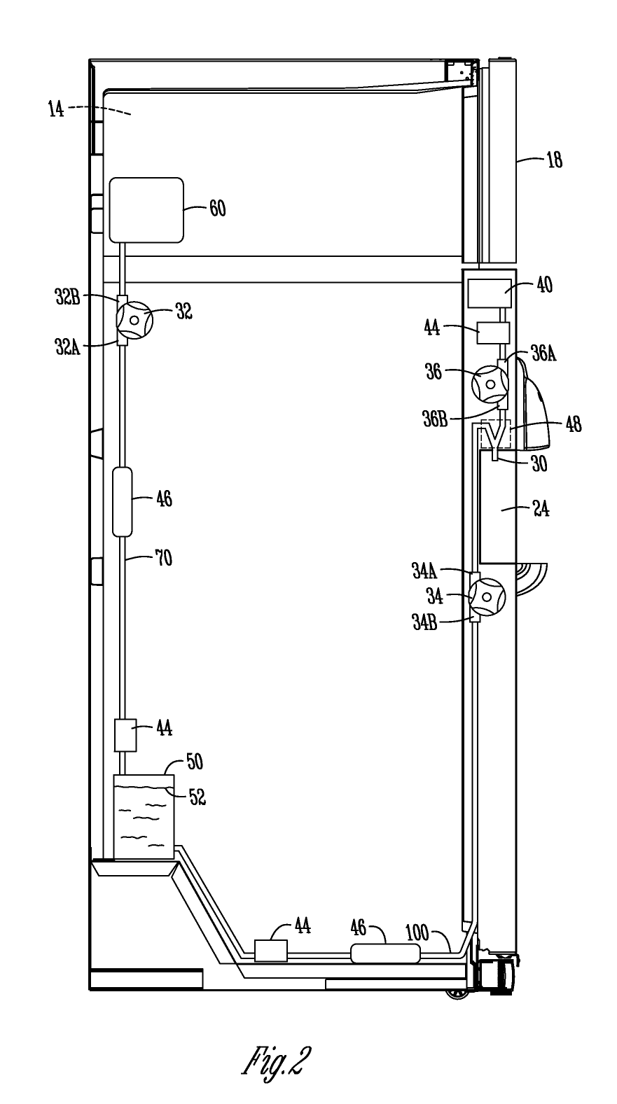

Referring to FIG. 1, an exemplary embodiment of the present invention is shown which provides significant advantages and benefits. A refrigerator 10 is shown to include a refrigerator cabinet 12 defining a freezer compartment 14 and a fresh food compartment 16. The freezer compartment 14 and fresh food compartment 16 are sealed by a freezer compartment door 18 and fresh food compartment door 20 respectively. Freezer compartment 14 is generally maintained below 0° C. temperature while the fresh food compartment 16 is maintained above 0° C. temperature. Disposed on the fresh food compartment door 20 is a dispenser 24, generally including an actuation surface 26, display 28, and dispenser spout 30. It can be appreciated that dispenser 24 can be found in refrigerators of side-by-side construction as well as other designs.

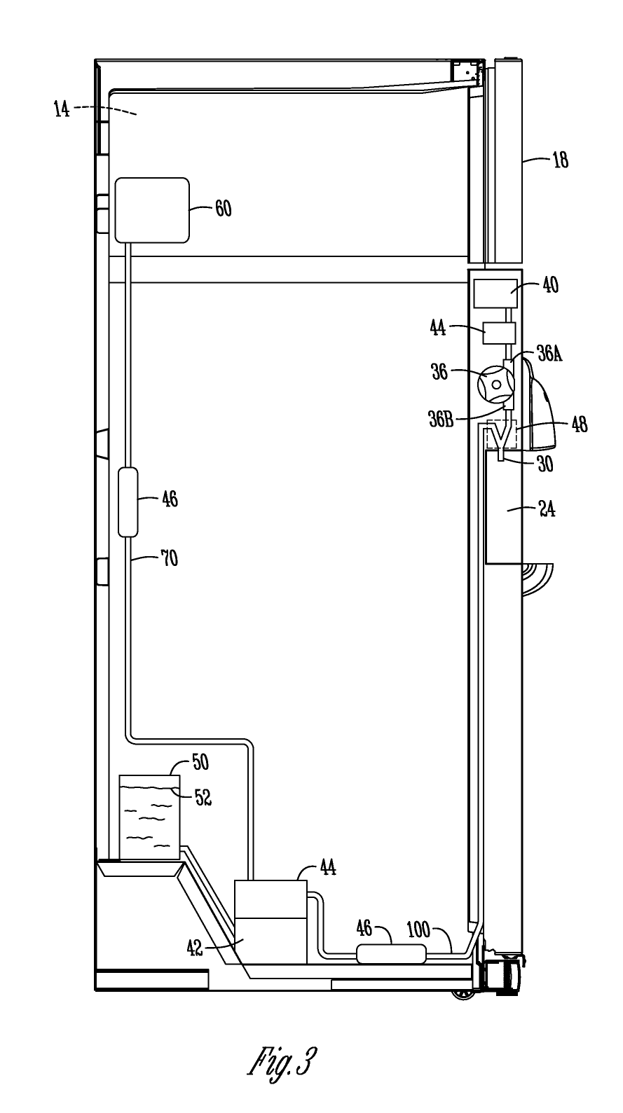

FIG. 2 provides a section view of a refrigerator taken along line 2-2 of FIG. 1. A liquid reservoir 50 may be disposed within the refrigerator cabinet and manually filled with water. The dispenser 24 may be mounted at the fresh food compartment door 20 for dispensing a liquid, a flavored beverage, a refillable bottle, or some combination thereof. The dispenser 24 is configured to have an outlet or dispenser spout 30 located above the liquid reservoir 50. A dispenser pump 34 may further be provided having an inlet 34A in communication with the liquid in the reservoir 50 and an outlet 34B in communication with the dispenser 24. In operation, the pump 34 draws liquid from the liquid reservoir 50 through the liquid reservoir line 100 for dispensing from the dispenser 24. The pumps used can be any positive displacement pump such as a Quantex pump made by Quantex Arc Ltd. Moreover, it can be appreciated that a conventional filtration device 46 may be disposed inline, e.g. liquid reservoir line 100, or used when a quantity of water is added to the reservoir 50.

As shown in FIG. 2, an icemaker pump 32 may be provided having an inlet 32A in communication with the liquid in the liquid reservoir 50 and an outlet 32B in communication with the icemaker 60. In operation, the icemaker pump 32 draws liquid from the liquid reservoir 50 through the icemaker line 102 to the icemaker 60 for the production of ice. A flavorant pump 36 may further be provided having an inlet 36A in communication with a flavored beverage or flavorant in the flavorant reservoir 40 and an outlet 36B in communication with the dispenser 24. Again, in operation, the flavorant pump 36 draws liquid from the flavorant reservoir 40 for dispensing from the dispenser 24. It can be appreciated, with reference to FIG. 2, that flavorant from the reservoir 40 may be mixed in mixing zone 48 with water drawn from reservoir 50 through line 100. In this manner various concentrates can be mixed with water to form a flavored beverage.

Referring again to FIG. 2, the dispenser outlet 30 is located above the reservoir 50. The reservoir 50 is manually filled with a liquid, such as water, to a liquid level 52. The embodiment shown in FIG. 2 shows three pumps, however, it can be appreciated that each pump can be used without other, i.e., any number of pumps can be used in conjunction or separately depending on the desired use. The embodiment further shows a plurality of coordinating valve(s) 44. The coordinating valve(s) 44 may be of a conventional solenoid type and arranged in an electric circuit connected to a suitable source of current. Thus, when a switch is closed the solenoid of the corresponding valve is energized and the valve is opened. It can be appreciated by a skilled artisan that the nonplumbed refrigerator of the present invention can be adapted to be free from valves. For instance, certain types of pumps can act themselves as valves, i.e., they are closed when not in operation, and thus the need for valves may be eliminated. It can further be appreciated that the same result may be achieved in a nonplumbed refrigerator free from valves as compared to a nonplumbed refrigerator using pumps that do not act like valves when not in operation in conjunction with a set of valves.

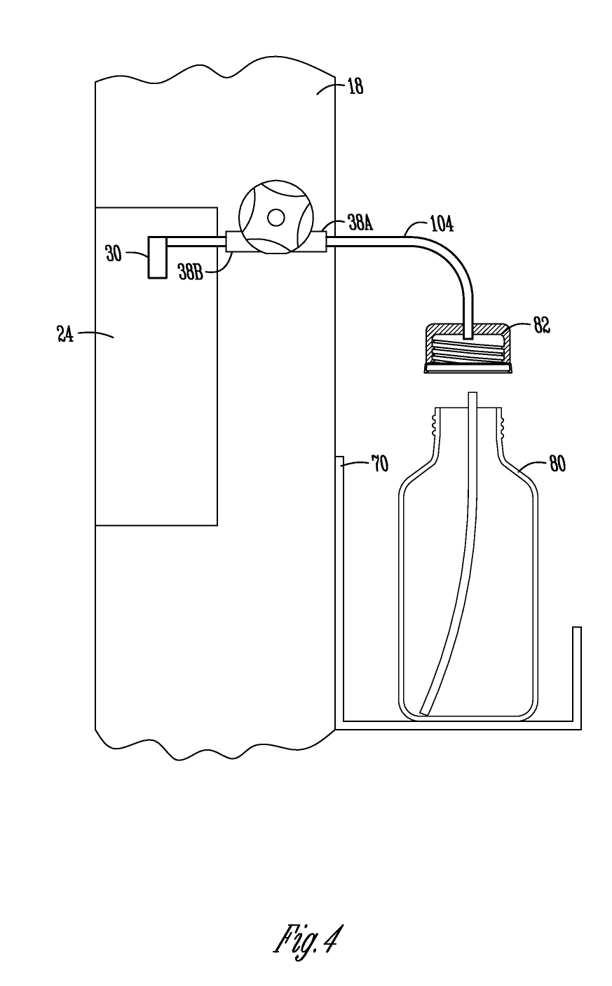

FIG. 3 is a section view taken along line 3-3 of FIG. 1 of an alternative embodiment of the present invention. Again, the dispenser 24 is located above the reservoir 50 in a non-plumbed refrigerator. A central pump 42 and coordinating valve(s) 44 are disposed within the refrigerator 10. The central pump 42 having an inlet(s) in communication with the reservoir 50 and outlet(s) in communication with the coordinating valve(s). The coordinating valves 44 further being in communication with the dispenser 24 and icemaker 60. In operation, the pump 42 draws water from reservoir 50 to at least one coordinating valve 44. The coordinating valve(s) 44 may be of a conventional solenoid type and arranged in an electric circuit connected to a suitable source of current. Thus, when a switch is closed the solenoids of the valves are energized and the valves are opened. Conventional filtration devices 46 may be disposed inline, e.g. liquid reservoir line 100, or when a quantity of water is added to the reservoir 50.

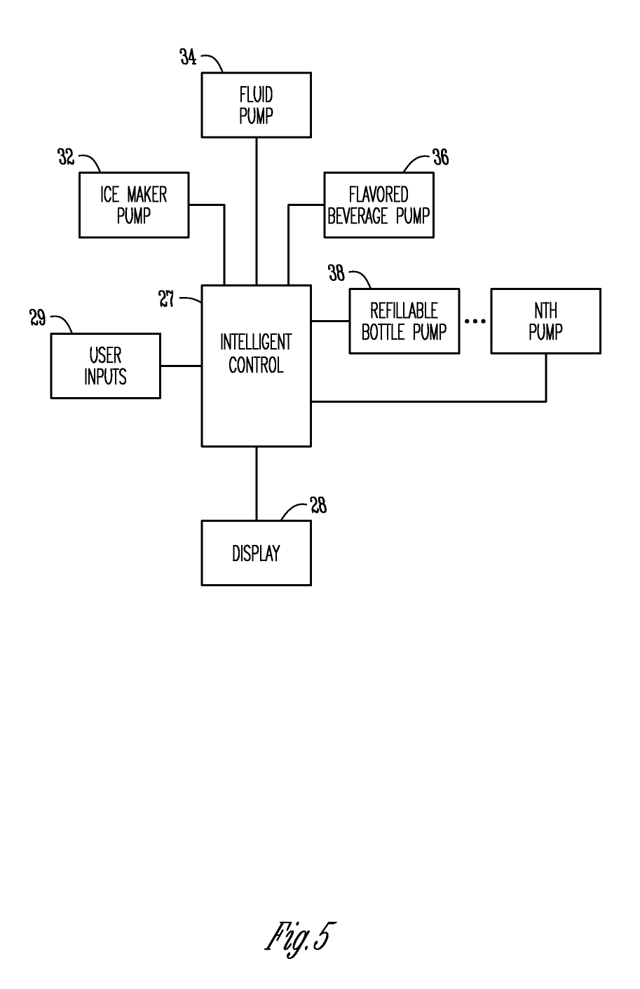

As shown in FIG. 4, it is further contemplated that a refillable bottle or a milk jug 80 may be used. The refillable bottle 80 may be secured, for instance, in a mating connection with a receiver 82 in the door bin 70. A refillable bottle pump 38 is provided having an inlet 38A in communication with the liquid in the refillable bottle 80 and an outlet 38B in communication with the dispenser. In operation, the refillable bottle pump 38 will draw a liquid from the refillable bottle 80 through a refillable bottle line 104 to the dispenser 24. It is anticipated that the liquid may be drawn from the refillable bottle 80 through any number of inserts that extend into and toward the bottom of the refillable bottle 80.

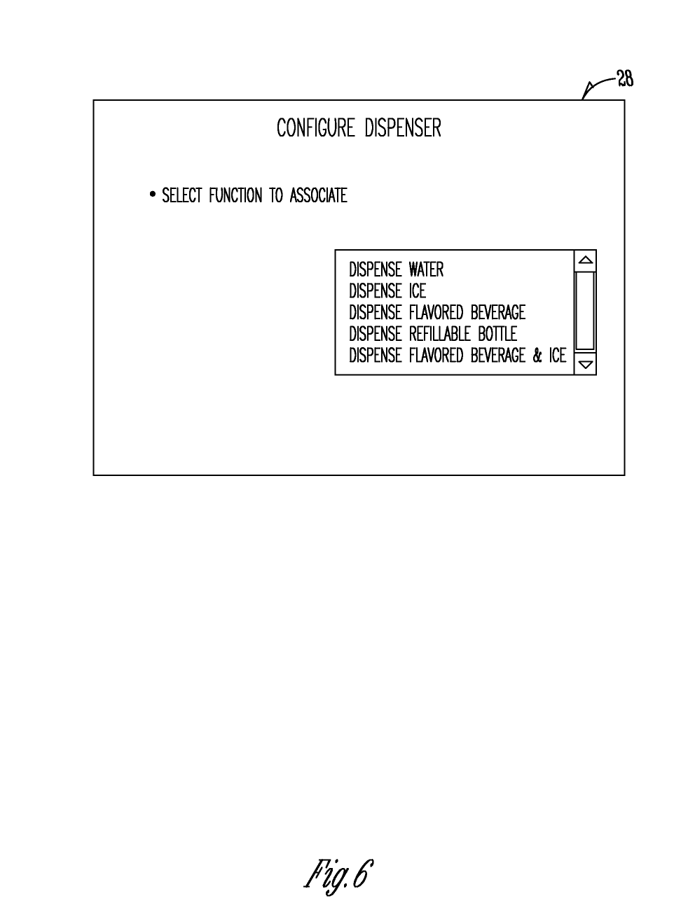

Now with reference to FIG. 5, a block diagram in accordance with the present invention is shown. Intelligent control 27 is used to control a plurality of pumps and a display 28 based on user inputs 29. The display 28 is shown in greater detail in FIG. 6. As can be seen, a user can configure the dispenser 24 by selecting a dispensing function input. Each dispensing function may be associated with one or more pumps. For example, a user can configure the dispenser 24 to dispense liquid, ice, flavored beverage, or a refillable bottle. The user would place a vessel under the dispenser spout 30 and then contact an actuation surface 26, such as a pad or lever. The intelligent control would then control one or more pumps based on the user inputs 52. For instance, if flavored beverage is desired the intelligent control 50 would actuate the flavorant pump. If filtered water is desired, the intelligent control 50 would actuate a dispenser pump. Alternatively, a single pump could be actuated to dispense both filtered water and a flavored beverage. It can be appreciated that any number of configurations can potentially be selected via the display 54 including setting the dispenser 24 to dispense water and ice, flavored beverage and ice or refillable bottle and ice.

Further provided is a method of operating a refrigerator including the steps of providing a refrigerator comprising a refrigerator cabinet, a door attached to the refrigerator cabinet, a liquid reservoir, and a dispenser mounted at the door for dispensing liquid through the door, the dispenser having an outlet located above the liquid reservoir, providing a pump having an inlet in communication with the liquid in the liquid reservoir and an outlet in communication with the dispenser, and providing a user interface in communication with the pump, whereby selectively entering a dispensing function input into the interface actuates the pump. In operation, the dispensing function is selected from the set consisting of liquid dispensing, ice dispensing, flavored beverage dispensing, and refillable bottle dispensing.

Having thus described a preferred embodiment and other embodiments of an apparatus and method for liquid dispensing and automatic icemaking on a non-plumbed refrigerator, it should be apparent to those skilled in the art that certain advantages of the present invention have been achieved. It should also be appreciated that various modifications, adaptations, and alternatives may be made. It is of course not possible to describe every conceivable combination of components for purposes of describing the present invention. All such possible modifications are to be included within the spirit and scope of the present invention which is to be limited only by the following claims.

What is claimed is:

1. A refrigerator comprising:
a refrigerator cabinet;
a door attached to the refrigerator cabinet;
a liquid reservoir;
a dispenser mounted at the refrigerator door for dispensing liquid through the door, the dispenser having an outlet located above the liquid reservoir; and
a pump having an inlet in communication with the reservoir and an outlet in communication with the dispenser.

2. The refrigerator according to claim 1 wherein the liquid reservoir is manually fillable.

3. The refrigerator according to claim 1 further comprising a valve having an inlet in communication with the pump and an outlet in communication with the dispenser.

4. The refrigerator according to claim 1 wherein the pump is a central pump having an inlet in communication with the liquid in the liquid reservoir and an outlet in communication with a plurality of valves, the valves being in communication with the dispenser and an icemaker.

5. The refrigerator according to claim 1 further comprising an icemaker pump having an inlet in communication with the liquid reservoir and an outlet in communication with an icemaker.

6. The refrigerator according to claim 1 further comprising a flavor reservoir in the refrigerator door.

7. The refrigerator according to claim 6 further comprising a flavorant pump having an inlet in communication with the flavor reservoir and an outlet in communication with the dispenser.

8. The refrigerator of claim 1, wherein the reservoir is a refillable bottle.

9. The refrigerator according to claim 1 further comprising a bin for receiving a refillable bottle and a refillable bottle pump having an inlet in communication with the refillable bottle and an outlet in communication with the dispenser.

10. The refrigerator of claim 1 further comprising a user interface at the door, the user interface in communication with the pump.

11. The refrigerator of claim 10 wherein the user interface is adapted to receive a dispensing function input that causes the pump to be actuated.

12. The refrigerator of claim 11 wherein the dispensing function input is selected from the set consisting of liquid dispensing, flavored beverage dispensing, and refillable bottle dispensing.

13. A refrigerator comprising:
a refrigerator cabinet;
a door attached to the refrigerator cabinet;
a liquid reservoir;
a dispenser mounted at the refrigerator door for dispensing liquid through the door, the dispenser having an outlet located above the liquid reservoir;
a pump having an inlet in communication with the reservoir and an outlet in communication with the dispenser; and
wherein a fluid flow path from the fluid reservoir to the dispenser is free from valves.

14. The refrigerator of claim 13, wherein the liquid reservoir is manually fillable.

15. The refrigerator of claim 14, further comprising an icemaker pump having an inlet in communication with the fluid reservoir and an outlet in communication with the icemaker.

16. A method of operating a refrigerator, comprising:
providing a refrigerator comprising a refrigerator cabinet, a door attached to the refrigerator cabinet, a liquid reservoir, and a dispenser mounted at the door for dispensing liquid through the door, the dispenser having an outlet located above the liquid reservoir;
providing a pump having an inlet in communication with the liquid reservoir and an outlet in communication with the dispenser; and
providing a user interface in communication with the pump, whereby selectively entering a dispensing function input into the interface actuates the pump.

17. The method according to claim 16 further comprising manually filling the liquid reservoir.

18. The method according to claim 16 wherein the pump is a central pump having an inlet in communication with the liquid in the liquid reservoir and an outlet in communication with a plurality of valves, the valves being in communication with the dispenser and an icemaker.

19. The method according to claim 16 further comprising providing an icemaker pump having an inlet in communication with the liquid reservoir and an outlet in communication with an icemaker.

20. The method according to claim 16 further comprising providing a flavorant pump having an inlet in communication with a flavor reservoir and an outlet in communication with the dispenser.

21. The method according to claim 20 further comprising associating the flavorant pump with a flavored beverage dispensing function on the user interface.

22. The method according to claim 16 further comprising providing a refillable bottle pump having an inlet in communication with a refillable bottle and an outlet in communication with the dispenser.

23. The method according to claim 22 further comprising associating the refillable bottle pump with the refillable bottle dispensing function on the user interface.

24. The method of claim 16 further comprising:
providing an icemaker pump having an inlet in communication with the liquid reservoir and an outlet in communication with an icemaker;
providing a flavorant pump having an inlet in communication with a flavor reservoir and an outlet in communication with the dispenser; and
providing a refillable bottle pump having an inlet in communication with a refillable bottle and an outlet in communication with the dispenser.

25. The method of claim 24 further comprising performing a dispensing function.

26. The method of claim 24 wherein the dispensing function is selected from the set consisting of liquid dispensing, flavored beverage dispensing, and refillable bottle dispensing.
